(19) United States
(12) Patent Application Publication
(10) Pub. No.: US 2026/0301122 A1
(43) Pub. Date: Oct. 1, 2026

(54) Electronic Devices and Corresponding Methods for Capturing and Synthesizing Images with Skeletal Model Alignment

(71) Applicant: Motorola Mobility LLC, Chicago, IL (US)

(72) Inventors: Amit Kumar Agrawal, Bangalore (IN); Rahul Bharat Desai, Hoffman Estates, IL (US); Shuoxuan Wang, Chicago, IL (US)

(21) Appl. No.: 19/096,009

(22) Filed: Mar. 31, 2025

(51) Int. Cl. G06T 5/50; G06T 7/62; G06T 7/70; G06T 11/60

(52) U.S. Cl. CPC G06T 5/50; G06T 7/62; G06T 7/70; G06T 11/60; G06T 2207/20221

(57) ABSTRACT

A method in an electronic device captures, with an image capture device, an image depicting a first subject. The method augments, by one or more processors, the image to depict a skeletal model of a second subject in a predefined position relative to depictions of the first subject to obtain an augmented image. The method then presents, by the one or more processors on a rear facing display, the augmented image while the image capture device is in a viewfinder mode of operation so that a subject can align with the skeletal model for the purpose of taking group photographs sequentially.

### BACKGROUND

### Technical Field

This disclosure relates generally to electronic devices, and more particularly to electronic devices having displays and image capture devices.

### Background Art

In recent years, the proliferation of smartphones with advanced capabilities has transformed how individuals capture and share moments. However, capturing group photos, especially in scenarios where the photographer wishes to be included, remains a challenge. Traditional methods, such as using selfie sticks or relying on strangers to take photos, often result in suboptimal compositions and can pose security risks, such as potential theft of the device. Additionally, existing solutions that require manual alignment of subjects in photos can be cumbersome and imprecise, leading to unsatisfactory results. It would be advantageous to have improved electronic devices and corresponding methods offering a more intuitive and efficient method to capture group photographs.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory method in accordance with one or more embodiments of the disclosure.

FIG. 3A illustrates one or more method steps in accordance with one or more embodiments of the disclosure.

FIG. 3B illustrates one or more method steps in accordance with one or more embodiments of the disclosure.

FIG. 3C illustrates one or more method steps in accordance with one or more embodiments of the disclosure.

FIG. 3D illustrates one or more method steps in accordance with one or more embodiments of the disclosure.

FIG. 4A illustrates one or more method steps in accordance with one or more embodiments of the disclosure.

FIG. 4B illustrates one or more method steps in accordance with one or more embodiments of the disclosure.

FIG. 4C illustrates one or more method steps in accordance with one or more embodiments of the disclosure.

FIG. 4D illustrates one or more method steps in accordance with one or more embodiments of the disclosure.

FIG. 5 illustrates another explanatory method in accordance with one or more embodiments of the disclosure.

FIG. 6 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to capturing, with an image capture device, an image depicting a first subject, augmenting, by one or more processors, the image to depict a skeletal model of a second subject in a predefined position relative to depictions of the first subject to obtain an augmented image, and presenting, by the one or more processors on a rear facing display, the augmented image while the image capture device is in a viewfinder mode of operation. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to, in response to an image capture device capturing an image depicting a first subject, augment the image with a model defined by reference locations situated at predefined features of a second subject at a position relative to depictions of the first subject to obtain an augmented image and cause the first display to present the augmented image while the image capture device is in a viewfinder mode of operation as described herein. The non-processor circuits may include, but are not limited to, a radio receiver, a radio transmitter, signal drivers, clock circuits, power source circuits, and user input devices.

As such, these functions may be interpreted as steps of a method to perform capturing, with an image capture device, an image depicting a first subject and determining, by one or more processors using one or more sensors of the electronic device, a distance between the first subject and the image capture device. The method may further comprise generating, by the one or more processors, a skeletal model of a second subject positioned at a predefined orientation relative to depictions of the first subject as a function of the distance between the first subject and the image capture device, superimposing, by the one or more processors, the skeletal model on the image to obtain an altered image, causing, by the one or more processors, a display positioned adjacent to the image capture device to present the altered image, and causing, by the one or more processors, viewfinder content to be presented with the altered image when a second subject is positioned within a field of view of the image capture device.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

In the realm of photography, capturing group compositions, particularly in dynamic environments such as vacations, presents a distinct set of challenges. Traditional methods often require the photographer to either rely on a selfie stick, engage in trial and error, or solicit assistance from passersby, which carries the risk of theft or mishandling of the device. Moreover, these methods are cumbersome and do not guarantee satisfactory results, as they often lack precision in aligning subjects within the frame.

Existing solutions, such as those offered by certain smartphone applications, attempt to address these challenges by providing manual alignment tools. However, these solutions place the burden of alignment entirely on the user, who is required to adjust their position based on visual feedback from the device's display. This process can be tedious and imprecise, leading to compositions that are often misaligned or aesthetically displeasing. Furthermore, these solutions typically require the user to repeatedly check the display, disrupting the natural flow of capturing spontaneous moments.

Advantageously, embodiments of the present disclosure address these limitations by leveraging the capabilities of multi-display devices, particularly those with foldable form factors. By utilizing an external display, embodiments of the disclosure provide a novel method for group composition, allowing users to accurately position themselves relative to a skeletal model superimposed on the initial image.

In one or more embodiments, a method in an electronic device enhances the process of capturing images by utilizing advanced image augmentation techniques. In one or more embodiments, the method involves capturing an image of a first subject using an image capture device and subsequently augmenting this image with a skeletal model of a second subject. This skeletal model is positioned in a predefined location relative to the depiction of the first subject, resulting in an augmented image. This model serves as a visual guide, enabling precise alignment without the need for frequent manual adjustments.

In one or more embodiments, the augmented image is then presented on a front-facing display while the image capture device operates in a viewfinder mode. This approach allows users to visualize the intended composition in real-time, facilitating precise alignment and improving the overall quality of group photographs. By leveraging the capabilities of multi-display devices, the method provides a seamless and intuitive user experience, addressing common challenges associated with capturing group photos, such as misalignment and the need for manual adjustments.

In some embodiments, the technology further enhances the user experience by integrating depth sensing technology, which facilitates the automatic generation of the skeletal model based on the subject's distance from the device. This innovative method not only simplifies the process of capturing group compositions but also significantly improves the quality and accuracy of the resulting images.

Advantageously, this method allows for real-time visualization of the intended composition, enabling users to align themselves or other subjects accurately without the need for manual adjustments. By superimposing a skeletal model onto the captured image, the method provides a visual guide that facilitates precise alignment, thereby improving the quality of group photographs.

This approach leverages the capabilities of multi-display devices to enhance user experience by reducing the trial-and-error process typically associated with capturing group photos. The use of a front-facing display in viewfinder mode allows users to see the augmented image as they position themselves, ensuring that the final composition meets their expectations. This method addresses common challenges in photography, such as misalignment and the need for repeated adjustments, by providing a more intuitive and efficient way to capture group images.

Advantageously, embodiments of the disclosure leverage the capabilities of multi-display electronic devices to enhance group photo compositions. In an electronic device equipped with both a multi-camera and multi-display system, the process facilitates a group composition, allowing the person taking the photo to be included in the final image.

In one or more embodiments, this is achieved through a two-step photo capture process, where the first photo is taken without the photographer, and the second photo includes the photographer. The external display, facing the subject, is utilized to present the first composition, while a skeletal model of the second subject is superimposed on this image using stereo depth information from the multi-camera system.

This visual guide enables the second subject to accurately position themselves within the composition, ensuring precise alignment. Once both compositions are captured, they are merged to create a seamless group photo. This method effectively addresses the challenges of aligning multiple compositions by utilizing the dual-display form factor, thereby improving the accuracy and aesthetic quality of the final image.

In one or more embodiments, an electronic device comprises a first housing portion that is pivotable relative to a second housing portion, thereby allowing the device to transition between a closed position and an axially displaced open position. In the closed position, the first display is concealed while the image capture device and a second display remain exposed, facilitating quick access to important functions without fully opening the device. In the open position, all components, including the image capture device, the first display, and the second display, are exposed, enabling full functionality.

In one or more embodiments, the device is equipped with one or more processors that operate in conjunction with the image capture device to enhance image capturing capabilities. Upon capturing an image depicting a first subject, the processors augment the image by incorporating a model defined by reference locations situated at predefined features of a second subject. This augmentation is performed to obtain an augmented image, which is then presented on the first display while the image capture device is in a viewfinder mode of operation. This configuration allows for improved user interaction and image composition, leveraging the dual-display and pivotable design to enhance the overall photographic experience

Advantageously, this configuration allows the device to offer quick access to important functions without fully opening the device, enhancing user convenience and efficiency. The pivotable design facilitates seamless transitions between different operational modes, optimizing the use of both displays for various tasks. The integration of one or more processors with the image capture device enables the augmentation of captured images with a model of a second subject, which is then presented on the first display in viewfinder mode.

This arrangement improves the user's ability to compose images by providing real-time visual feedback, thereby enhancing the quality of the captured images. The dual-display setup, combined with the pivotable housing, offers a versatile platform for capturing and viewing images, addressing common challenges in mobile photography, such as misalignment and the need for manual adjustments.

In one or more embodiments, a method in an electronic device comprises capturing an image of a first subject using an image capture device and determining the distance between the first subject and the image capture device through one or more processors utilizing sensors of the electronic device. In one or more embodiments, this distance measurement is usefuk for generating a skeletal model of a second subject, which is positioned at a predefined orientation relative to the depiction of the first subject.

In one or more embodiments, the skeletal model is superimposed on the captured image to create an altered image, which is then displayed on a screen adjacent to the image capture device. This display allows for real-time visualization of the altered image, facilitating precise alignment of the second subject within the field of view of the image capture device. In one or more embodiments, the method further includes presenting viewfinder content alongside the altered image, enhancing the user's ability to accurately position the second subject, thereby improving the overall composition and quality of the captured images.

Advantageously, this method allows for precise alignment of subjects in a photograph by utilizing depth information to generate a skeletal model that guides the positioning of a second subject relative to a first subject. By determining the distance between the first subject and the image capture device, the method ensures that the skeletal model is accurately scaled and positioned, facilitating the creation of a well-composed image.

The superimposition of the skeletal model on the captured image provides a visual guide for the second subject, enabling them to align themselves correctly within the frame. This approach reduces the need for manual adjustments and trial-and-error positioning, enhancing the efficiency and accuracy of capturing group photographs. The real-time display of the altered image with viewfinder content further aids in achieving the desired composition, improving the overall quality of the captured images.

Other advantages will be described below. Still others will be obvious to those of ordinary skill in the art having the benefit of this disclosure.

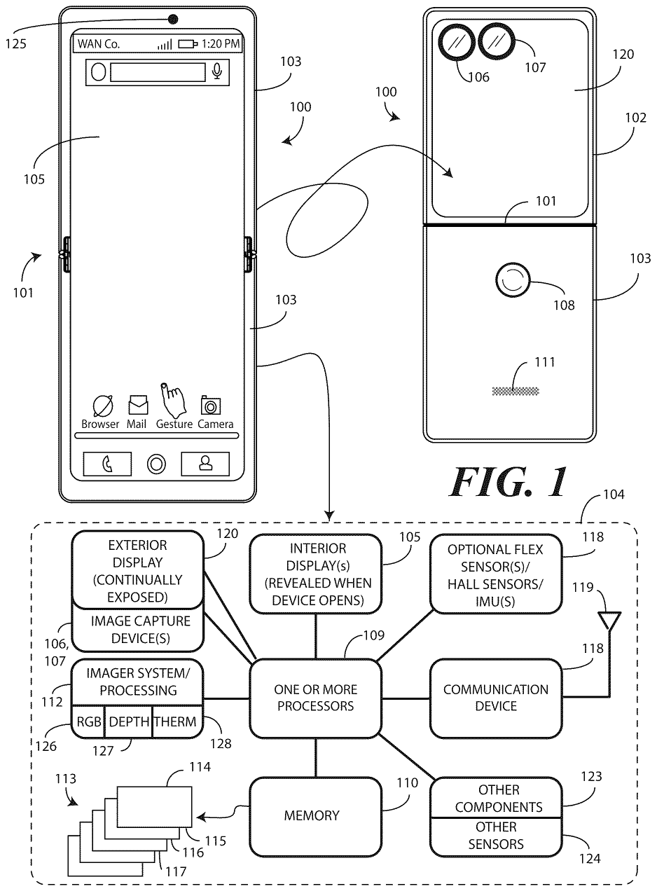

Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, multimedia players, and so forth. Still other types of electronic devices can be configured in accordance with one or more embodiments of the disclosure as will be readily appreciated by those of ordinary skill in the art having the benefit of this disclosure.

The electronic device 100 includes a first device housing 102 and a second device housing 103. In one or more embodiments, a hinge 101 couples the first device housing 102 to the second device housing 103. In one or more embodiments, the first device housing 102 is selectively pivotable about the hinge 101 relative to the second device housing 103.

For example, in one or more embodiments the first device housing 102 is selectively pivotable about the hinge 101 between a closed position, a partially open position, and the open position shown in FIG. 1 where the first device housing 102 is in an axially displaced open position relative to the second device housing 103 about the hinge 101.

In one or more embodiments the first device housing 102 and the second device housing 103 are manufactured from a rigid material such as a rigid thermoplastic, metal, or composite material, although other materials can be used. Still other constructs will be obvious to those of ordinary skill in the art having the benefit of this disclosure. In the illustrative embodiment of FIG. 1, the electronic device 100 includes a single hinge 101. However, in other embodiments two or more hinges can be incorporated into the electronic device 100 to allow it to be folded in multiple locations.

While the illustrative electronic device 100 of FIG. 1 includes a hinge 101, embodiments of the disclosure are not so limited. In other embodiments, the electronic device 100 will be bendable, but will not include a hinge 101, such as when the first device housing 102 and the second device housing 103 are manufactured from bendable materials. In still other embodiments, the electronic device 100 can be bendable via a combination of hinge components and non-hinge components.

Illustrating by example, in another embodiment the electronic device housing can exclude a hinge and instead be flexible with a bending region that allows the electronic device housing to bend and flex between the axially displaced open position and the closed position. In such an embodiment, the electronic device housing may be manufactured from a malleable, bendable, or physically deformable material such as a flexible thermoplastic, flexible composite material, flexible fiber material, flexible metal, organic or inorganic textile or polymer material, or other materials. The electronic device housing could be formed from a single flexible housing member or from multiple flexible housing members.

In other embodiments, the electronic device housing could be a composite of multiple components. For instance, in another embodiment the electronic device housing could be a combination of rigid segments connected by hinges or flexible materials. Still other constructs will be obvious to those of ordinary skill in the art having the benefit of this disclosure.

In one or more embodiments the electronic device 100 of FIG. 1 includes at least one display 105. The illustrative embodiment of FIG. 1 includes multiple displays. Display 105 serves as a first display and is also referred to as the interior display or the rear-facing display.

In this illustrative embodiment, display 105 is concealed when the first device housing 102 is pivoted about the hinge 101 relative to the second device housing 103 to a closed position. Display 105 is then revealed when the first device housing 102 is pivoted about the hinge 101 relative to the second device housing 103 from the closed position to an axially displaced open position shown in FIG. 1. Thus, display 105 is revealed as the electronic device 100 transitions from the closed position where the first device housing 102 and the second device housing 103 abut to conceal the rear facing display 105 to the open position of FIG. 1.

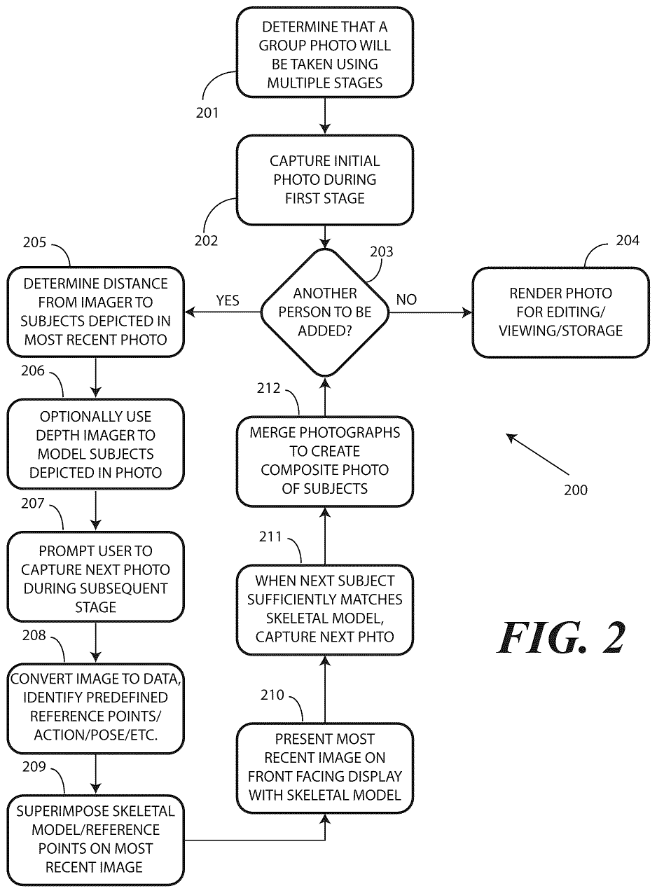

The electronic device 100 can optionally include at least one additional display. In the illustrative embodiment of FIG. 1, the electronic device 100 includes a front display 120, which can be referred to as an exterior display or front-facing display. This nomenclature regarding the “front facing display” and “rear facing display” arises due to the fact that the front display 120 is exposed both when the first device housing 102 and the second device housing 103 are pivoted about the hinge 101 to the closed position or the axially displaced open position. Thus, the front display 120 is exposed both in the axially displaced open position of FIG. 1 and the closed position of FIG. 2. In one or more embodiments, each of the rear display 105 and the front display 120 is a high-resolution display.

While shown coupled to the first device housing 102, it should be noted that the front display 120 could be coupled to either of the first device housing 102 or the second device housing 103. In other embodiments, the front display 120 can be coupled to the first device housing 102, while a third display (not shown) is coupled to the second device housing 103, and so forth. Thus, electronic devices configured in accordance with embodiments of the disclosure can include displays situated at different positions.

As with the front display 120, display 105 can also be coupled to either or both of the first device housing 102 or the second device housing 103. In this illustrative embodiment, display 105 is coupled to both the first device housing 102 and the second device housing 103 and spans the hinge 101. As noted above, display 105 is considered to be an “interior” display because it is concealed when the first device housing 102 and the second device housing 103 are in the closed position.

In one or more embodiments, either or both of display 105 and front display 120 can be touch-sensitive. Where this is the case, users can deliver user input to one or both of display 105 or the front display 120 by delivering touch input from a finger, stylus, or other objects disposed proximately with display 105 or the front display 120.

In the illustrative embodiment of FIG. 1, since display 105 spans the hinge 101, it is configured as a flexible display that can bend, deflect, and deform into different shapes. For instance, in one embodiment display 105 is configured as a foldable organic light emitting diode (OLED) display coupled to a foldable substrate.

The foldable substrate can be manufactured from various materials, including flexible plastic layers, flexible metal layers, flexible composite layers, or of other materials. In one embodiment, the foldable substrate is manufactured from stainless steel. Others will be obvious to those of ordinary skill in the art having the benefit of this disclosure. Where manufactured with a foldable substrate, this substrate allows display 105 to be flexible so as to deform when the first device housing 102 pivots about the hinge 101 relative to the second device housing 103.

In one or more embodiments, a user interface component 108, which may be a button or touch sensitive surface, can also be disposed along one or both of the first device housing 102 and/or the second device housing 103 to facilitate control of the electronic device 100. A speaker port 111 can be placed nearby.

In the illustrative embodiment of FIG. 1, the user interface component 108 comprises a button positioned on the second device housing 103. In other embodiments, the user interface component will be placed on the side of the first device housing 102 or second device housing 103, or to the side of front display 120. In still other embodiments, such as when the user interface component 108 is configured as a fingerprint sensor, it may be placed beneath the front facing display 120. Other locations for the user interface component 108 will be obvious to those of ordinary skill in the art having the benefit of this disclosure.

Other features can be added and can be located on the front of one or both of the first device housing 102 and/or the second device housing 103, sides of one or both of the first device housing 102 and/or the second device housing 103, and/or the rear of one or both of the first device housing 102 and/or the second device housing 103. Illustrating by example, in one or more embodiments a first image capture device 106 can be disposed on one side of the electronic device 100, while a second image capture device 125 is disposed on another side of the electronic device 100.

In the illustrative embodiment of FIG. 1, the first image capture device 106 and a third image capture device 107 are disposed on a front-facing side of the first device housing 102, while the second image capture device 125 is situated on a rear-facing side of the first device housing 102. As shown in FIG. 1, in this illustrative embodiment the front facing display 120 has a display perimeter that is defined by the outermost boundary of the area occupied by the front facing display 120 on the second device housing 103. In this illustrative embodiment, the first image capture device 106 and the third image capture device 107 are situated within this display perimeter.

In one or more embodiments, the first image capture device 106 and the third image capture device 107 can be different types of image capture devices. Illustrating by example, the first image capture device 106 may be a wide field of view image capture device, while the third image capture device 107 is a telephoto image capture device, and so forth. In one or more embodiments, the first image capture device 106 and the third image capture device 107 can be used to capture images of front-facing subjects, while the second image capture device 125 can be used for rear-facing subjects, such as when a user of the electronic device 100 is capturing a “selfie.”

In other embodiments, the first image capture device 106 and the third image capture device 107 could be positioned beneath the front facing display 120. Illustrating by example, in such an embodiment the front facing display 120 may comprise a first pixel portion and a second pixel portion. In one embodiment, the first pixel portion comprises only transparent organic light emitting diode pixels. In another embodiment, the pixels disposed in the first pixel portion comprise a combination of transparent organic light emitting diode pixels and reflective organic light emitting diode pixels. Other configurations will be obvious to those of ordinary skill in the art having the benefit of this disclosure.

In such an embodiment, the entire extent of the front facing display 120 would be available for presenting images. In the illustrative embodiment of FIG. 1, the first image capture device 106 and the third image capture device 107 are situated within apertures defined by the extent of the front facing display 120 within the outer display perimeter. As such, content is not presented within the outer perimeters of the first image capture device 106 and the third image capture device 107. This configuration allows for lenses and other components to be situated atop the image sensors of each of the first image capture device 106 and the third image capture device 107.

While some borders are shown in FIG. 1, in other embodiments there is no need for the first device housing 102 of the electronic device 100 to include borders that picture frame the front facing display 120 or the rear facing display 105. To the contrary, in other embodiments one or both of the rear facing display 105 and/or the front facing display 120 can span an entire major face of the electronic device 100 so that the entirety of the major face can be used as active display area.

One way that the amount of surface area of the first device housing 102 and the second device housing 103 covered by the rear display 105 or the front display 120 can be expanded is by placing the various sensors, e.g., image capture devices and the fingerprint sensor, beneath the first pixel portion of a display as previously described. This allows the fingerprint sensor, the image capture devices, and/or the other sensors to receive signals through the transparent portions of the first pixel portion.

A block diagram schematic 104 of the electronic device 100 is also shown in FIG. 1. In one or more embodiments, the block diagram schematic 104 is configured as a printed circuit board assembly disposed within one or both of the first device housing 102 or the second device housing 103. Various components can be electrically coupled together by conductors or a bus disposed along one or more printed circuit boards, which can optionally be flexible circuit boards or alternatively rigid circuit boards coupled together by one or more flexible conductors or substrates. It should be noted that the block diagram schematic 104 includes many components that are optional, but which are included in an effort to demonstrate how varied electronic devices configured in accordance with embodiments of the disclosure can be.

Thus, it is to be understood that the block diagram schematic 104 of FIG. 1 is provided for illustrative purposes only and for illustrating components of one electronic device 100 in accordance with embodiments of the disclosure. The block diagram schematic 104 of FIG. 1 is not intended to be a complete schematic diagram of the various components required for an electronic device 100. Therefore, other electronic devices in accordance with embodiments of the disclosure may include various other components not shown in FIG. 1 or may include a combination of two or more components or a division of a particular component into two or more separate components and still be within the scope of the present disclosure.

In one embodiment, the electronic device 100 includes one or more processors 109. The one or more processors 109 can be a microprocessor, a group of processing components, one or more Application Specific Integrated Circuits (ASICs), programmable logic, or other type of processing device. The one or more processors 109 can be operable with the various components of the electronic device 100. The one or more processors 109 can be configured to process and execute executable software code to perform the various functions of the electronic device 100. A storage device, such as memory 110, can optionally store the executable software code used by the one or more processors 109 during operation.

In one or more embodiments, the one or more processors 109, upon either the first image capture device 106 or the third image capture device 107 capturing an image depicting a first subject, augment the image with a model defined by reference locations situated at predefined features of a second subject at a position relative to depictions of the first subject to obtain an augmented image. In one or more embodiments, the one or more processors 109 cause the front-facing display 120 to present the augmented image while either the first image capture device 106 or the third image capture device 107 is in a viewfinder mode of operation.

In one or more embodiments, the one or more processors 109 are further configured to present at least portions of viewfinder image content depicting a second subject with the augmented image while either the first image capture device 106 or the third image capture device 107 is in the viewfinder mode of operation when the second subject is within a field of view of either the first image capture device 106 or the third image capture device 107 that is capturing the next image.

In one or more embodiments, the one or more processors 109 cause either the first image capture device 106 or the third image capture device 107 to capture another image once the at least portions of the viewfinder image content depict the second subject overlapping the model by a predefined overlapping amount. In one or more embodiments, the one or more processors 109 further synthesize the image and the another image to obtain a composite image depicting the first subject and the second subject at the position relative to the depictions of the first subject.

In effect, the one or more processors 109 facilitate group composition photographs by capturing sequential images and using an external display 120 of a multi-display device. In one or more embodiments, the one or more processors 109 use either the first image capture device 106 or the third image capture device 107 in a sequence of steps designed to enhance the process of capturing group photographs.

Initially, the one or more processors 109 use one or more sensors 124 or a user interface such as the rear-facing display 105 to determine that a group composition is being initiated with the photographer needing to be included in the final image. In one or more embodiments, this process requires capturing two separate images: a first image excludes the photographer and a second image that includes the photographer.

In one or more embodiments during the first image capture, the rear facing display 105 shows the camera preview captured by either the first image capture device 106 or the third image capture device 107, while the front facing display 120 facing the subject, is activated. Upon either the first image capture device 106 or the third image capture device 107 capturing the first image, the one or more processors 109 use a depth imager 127 to recordd the distance to the first subject. Advantageously, this distance measurement ensures precise spatial data is available for subsequent steps.

After the first composition is complete, the one or more processors 109 prompt the photographer to capture the second image, which the one or more processors 109 will superimpose on the first image. In one or more embodiments, the one or more processors 109 cause the front facing display 120 to present the first composition combined with a skeletal cutout of the second subject that is superimposed on this first image using stereo depth information from the depth imager. This “visual guide” allows the second user to accurately position themselves within the composition. Once both compositions are captured, they are merged to create a seamless group photo, effectively addressing the challenges of aligning multiple compositions by leveraging the dual-display form factor.

Thus, in one or more embodiments the one or more processors 109 augment the first image by superimposing the model on the first image. Where the electronic device 100 comprises a depth imager 127, the one or more processors 109 can use a distance the first subject is from either the first image capture device 106 or the third image capture device 107 when the first image is captured as an input into a function determining the size of the model. In other embodiments, such as where the first image depicts an inanimate object like a car, building, house, tree, light post, restaurant such as the world famous Buster's Chicken Shack, or other inanimate object, a size of the model can be determined as a function of the size of depictions of the first subject in comparison to a size of the depictions of the inanimate object.

It should be noted that in this illustrative embodiment both of the first image capture device 106 and the third image capture device 107 are coupled to the first device housing 102 and are each exposed both when the first device housing 102 and the second device housing 103 are in the closed position and when the first device housing 102 and the second device housing 103 are in the axially displaced open position of FIG. 1. Embodiments of the disclosure contemplate that when the electronic device 100 is in the axially displaced open position, users will typically use the rear facing display 105 as a user interface since the rear facing display 105 is generally a touch-sensitive display.

In one or more embodiments, the one or more processors 109 are further responsible for performing the primary functions of the electronic device 100. For example, in one embodiment the one or more processors 109 comprise one or more circuits operable to present presentation information, such as images, text, and video, on one or both of the rear facing display 105 and/or the front facing display 120. The executable software code used by the one or more processors 109 can be configured as one or more modules 113 stored in the memory 110 that are operable with the one or more processors 109. Such modules can store instructions, control algorithms, and so forth.

In one embodiment, the one or more processors 109 are responsible for running the operating system environment 114. The operating system environment can include a kernel 115, one or more drivers, and an application service layer 116, and an application layer 117. The operating system environment can be configured as executable code operating on one or more processors or control circuits of the electronic device 100.

In one or more embodiments, the one or more processors 109 are responsible for managing the applications of the electronic device 100. In one or more embodiments, the one or more processors 109 are also responsible for launching, monitoring and killing the various applications and the various application service modules. The applications of the application layer can be configured as clients of the application service layer to communicate with services through application program interfaces (APIs), messages, events, or other inter-process communication interfaces.

In this illustrative embodiment, the electronic device 100 also includes a communication device 118 that can be configured for wired or wireless communication with one or more other devices or networks. The networks can include a wide area network, a local area network, and/or personal area network. The communication device 118 may also utilize wireless technology for communication, such as, but are not limited to, peer-to-peer or ad hoc communications, and other forms of wireless communication such as infrared technology. The communication device 118 can include wireless communication circuitry, one of a receiver, a transmitter, or transceiver, and one or more antennas 119.

In one embodiment, the electronic device 100 includes one or more sensors 124 operable to determine a geometric form factor of the electronic device 100. Illustrating by example, in one or more embodiments the one or more sensors 124 operable to detect the geometric form factor of the electronic device 100 detect angles between the first device housing 102 and the second device housing 103 as these device housings pivot relative to each other about the hinge 101. The one or more sensors 124 operable to determine a geometric form factor of the electronic device 100 can detect the first device housing 102 pivoting about the hinge 101 relative to the second device housing 103. The one or more sensors 124 operable to determine the geometric form factor can take various forms.

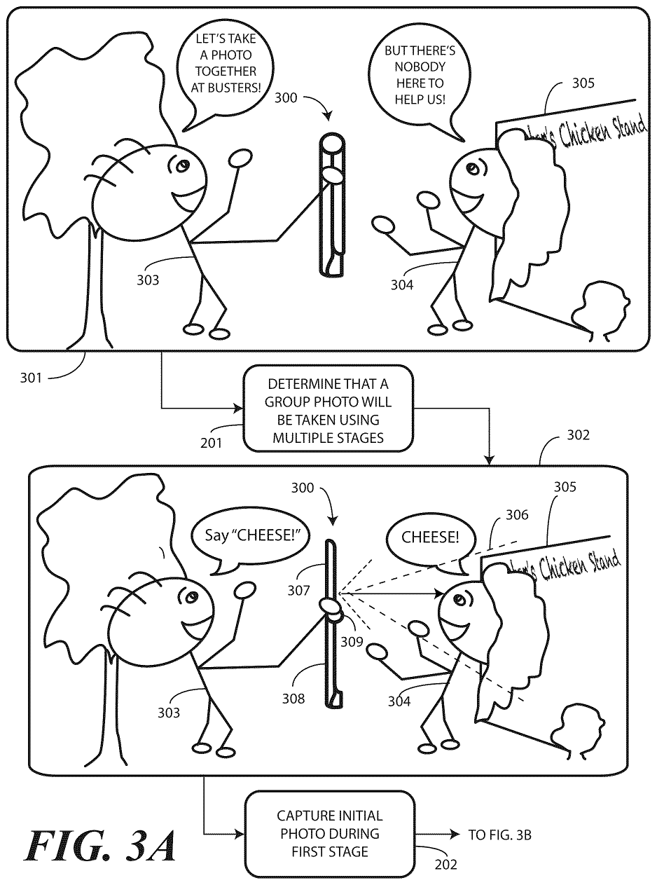

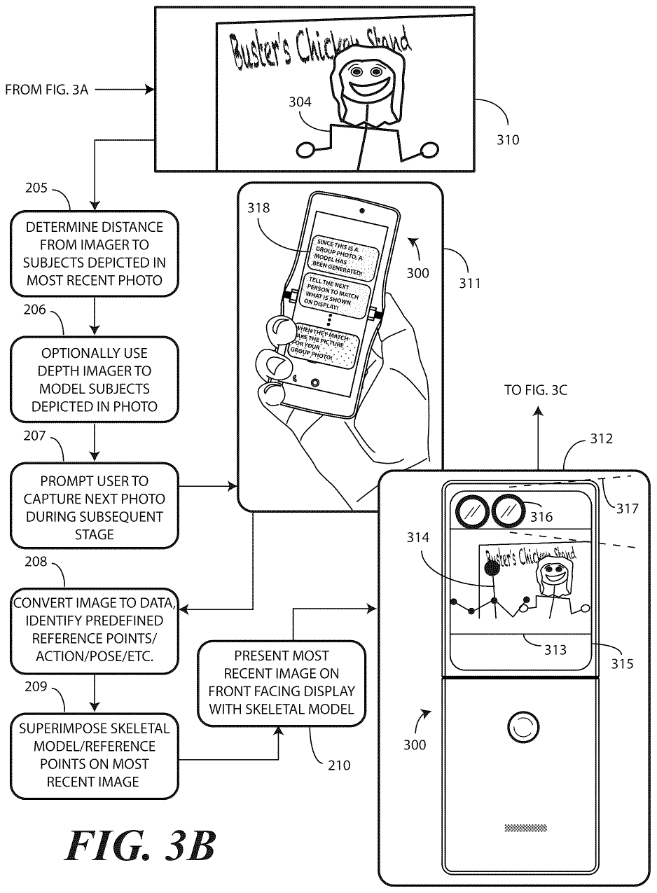

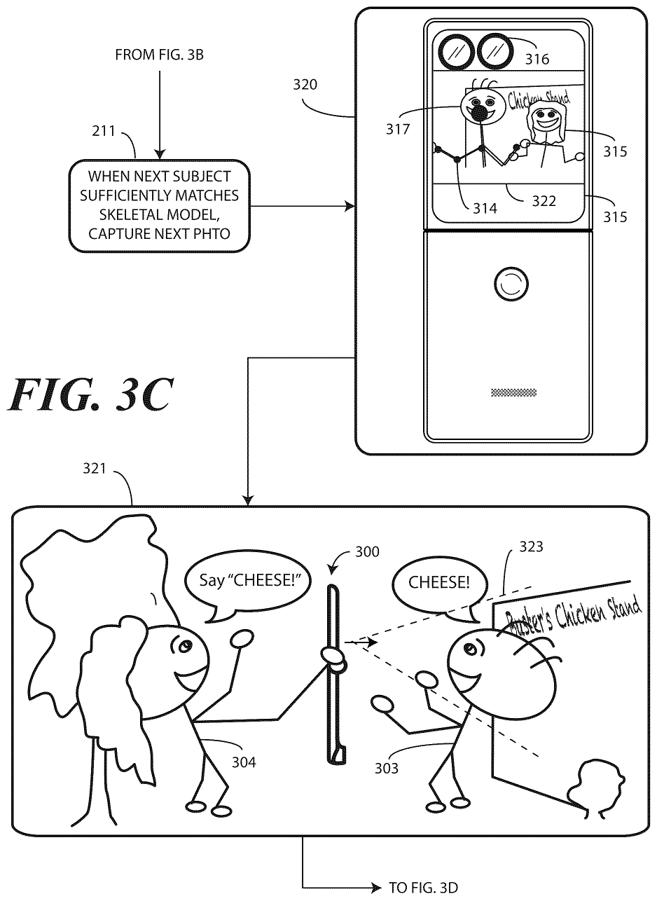

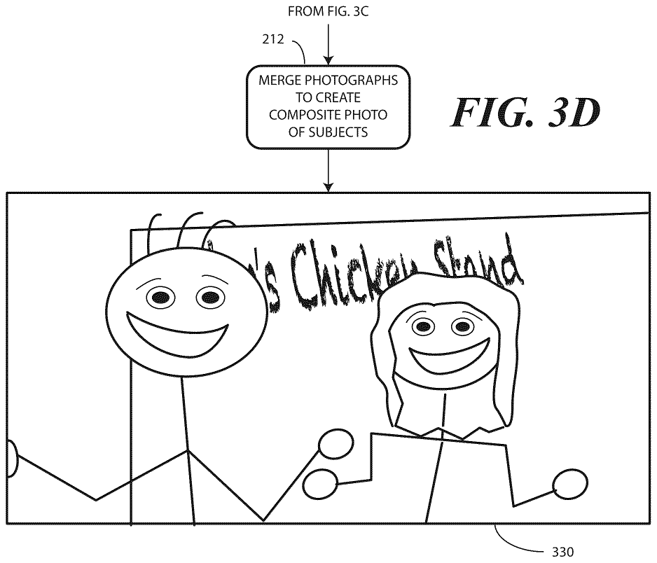

In one or more embodiments, the one or more sensors 124 operable to determine the geometric form factor of the electronic device 100 comprise one or more flex sensors supported by the first device housing 102 and/or second device housing 103 and operable with the one or more processors 109 to detect a bending operation deforming the electronic device 100 into a deformed geometric form factor, examples of which are shown below in FIGS. 2 and 3. The inclusion of flex sensors is optional, and in some embodiment flex sensors will not be included.

Where included, in one embodiment the flex sensors each comprise passive resistive devices manufactured from a material with an impedance that changes when the material is bent, deformed, or flexed. By detecting changes in the impedance as a function of resistance, the one or more processors 109 can use the one or more flex sensors to detect bending or flexing. In one or more embodiments, each flex sensor comprises a bi-directional flex sensor that can detect flexing or bending in two directions. In one embodiment, the one or more flex sensors have an impedance that increases in an amount that is proportional with the amount it is deformed or bent.

In one embodiment, each flex sensor is manufactured from a series of layers combined together in a stacked structure. In one embodiment, at least one layer is conductive, and is manufactured from a metal foil such as copper. A resistive material provides another layer. These layers can be adhesively coupled together in one or more embodiments. The resistive material can be manufactured from a variety of partially conductive materials, including paper-based materials, plastic-based materials, metallic materials, and textile-based materials. In one embodiment, a thermoplastic such as polyethylene can be impregnated with carbon or metal so as to be partially conductive, while at the same time being flexible.

In one embodiment, the resistive layer is sandwiched between two conductive layers. Electrical current flows into one conductive layer, through the resistive layer, and out of the other conductive layer. As the flex sensor bends, the impedance of the resistive layer changes, thereby altering the flow of current for a given voltage. The one or more processors 109 can detect this change to determine an amount of bending. Taps can be added along each flex sensor to determine other information, including the number of folds, the degree of each fold, the location of the folds, the direction of the folds, and so forth. The flex sensor can further be driven by time-varying signals to increase the amount of information obtained from the flex sensor as well.

While a multi-layered device as a flex sensor is one configuration suitable for detecting a bending operation occurring to deform the electronic device 100 and a geometric form factor of the electronic device 100 after the bending operation, other sensors 124 for detecting the geometric form factor of the electronic device 100 can be used as well. For instance, a magnet can be placed in the first device housing 102 while a magnetic sensor is placed in the second device housing 103, or vice versa. The magnetic sensor could be Hall-effect sensor, a giant magnetoresistance effect sensor, a tunnel magnetoresistance effect sensor, an anisotropic magnetoresistive sensor, or other type of sensor.

In still other embodiments, the one or more sensors 124 operable to determine a geometric form factor of the electronic device 100 can comprise an inductive coil placed in the first device housing 102 and a piece of metal placed in the second device housing 103, or vice versa. When the metal is in close proximity to the coil, the one or more sensors 124 operable to determine the geometric form factor of the electronic device 100 detect the first device housing 102 and the second device housing 103 in a first position. By contrast, when the metal is farther away from the coil, the one or more sensors 124 operable to determine a geometric form factor of the electronic device 100 can detect the first device housing 102 and the second device housing 103 being in a second position, and so forth.

In other embodiments the one or more sensors 124 operable to determine a geometric form factor of the electronic device 100 can comprise an inertial motion unit situated in the first device housing 102 and another inertial motion unit situated in the second device housing 103. The one or more processors 109 can compare motion sensor readings from each inertial motion unit to track the relative movement and/or position of the first device housing 102 relative to the second device housing 103, as well as the first device housing 102 and the second device housing 103 relative to the direction of gravity. This data can be used to determine and or track the state and position of the first device housing 102 and the second device housing 103 directly as they pivot about the hinge 101, as well as their orientation with reference to a direction of gravity.

Where included as the one or more sensors 124 operable to determine the geometric form factor of the electronic device 100, each inertial motion unit can comprise a combination of one or more accelerometers, one or more gyroscopes, and optionally one or more magnetometers, to determine the orientation, angular velocity, and/or specific force of one or both of the first device housing 102 or the second device housing 103. When included in the electronic device 100, these inertial motion units can be used as orientation sensors to measure the orientation of one or both of the first device housing 102 or the second device housing 103 in three-dimensional space. Similarly, the inertial motion units can be used as orientation sensors to measure the motion of one or both of the first device housing 102 or second device housing 103 in three-dimensional space. The inertial motion units can be used to make other measurements as well.

Where only one inertial motion unit is included in the first device housing 102, this inertial motion unit is configured to determine an orientation, which can include measurements of azimuth, plumb, tilt, velocity, angular velocity, acceleration, and angular acceleration, of the first device housing 102. Similarly, where two inertial motion units are included, with one inertial motion unit being situated in the first device housing 102 and another inertial motion unit being situated in the second device housing 103, each inertial motion unit determines the orientation of its respective device housing. Inertial motion unit can determine measurements of azimuth, plumb, tilt, velocity, angular velocity, acceleration, angular acceleration, and so forth of the first device housing 102, while inertial motion unit can determine measurements of azimuth, plumb, tilt, velocity, angular velocity, acceleration, angular acceleration, and so forth of the second device housing 103, and so forth.

In one or more embodiments, each inertial motion unit delivers these orientation measurements to the one or more processors 109 in the form of orientation determination signals. Thus, the inertial motion unit situated in the first device housing 102 outputs a first orientation determination signal comprising the determined orientation of the first device housing 102, while the inertial motion unit situated in the second device housing 103 outputs another orientation determination signal comprising the determined orientation of the second device housing 103.

In one or more embodiments, the orientation determination signals are delivered to the one or more processors 109, which report the determined orientations to the various modules, components, and applications operating on the electronic device 100. In one or more embodiments, the one or more processors 109 can be configured to deliver a composite orientation that is an average or other combination of the orientation of orientation determination signals. In other embodiments, the one or more processors 109 are configured to deliver one or the other orientation determination signal to the various modules, components, and applications operating on the electronic device 100.

In another embodiment the one or more sensors 124 operable to determine the geometric form factor of the electronic device 100 comprise proximity sensors that detect how far a first end of the electronic device 100 is from a second end of the electronic device 100. Still other examples of the one or more sensors 124 operable to determine a geometric form factor of the electronic device 100 will be obvious to those of ordinary skill in the art having the benefit of this disclosure.

In one or more embodiments, the one or more sensors 124 operable to determine the geometric form factor of the electronic device 100 can comprise an image capture analysis/synthesis manager 112. When the electronic device 100 is bent at the hinge 101 with, for example, the rear facing image capture device 125 determining the geometric form factor by processing images from the rear facing image capture device 125 to determine the angle of the bend.

In one or more embodiments, one or more of the first image capture device 106, the second image capture device 125, and the third image capture device 107 comprise an intelligent imager. Where configured as an intelligent imager, each image capture device 106,107,125 can capture one or more images of environments about the electronic device 100 and determine whether the object matches predetermined criteria.

For example, the intelligent imager operates as an identification module configured with optical recognition such as include image recognition, character recognition, visual recognition, facial recognition, color recognition, shape recognition and the like. In yet another embodiment, the intelligent imager can determine where a user's eyes or face are located in three-dimensional space relative to the electronic device 100.

To capture data depicting a subject performing the activity, a variety of devices, alone or in combination, can be included in the block diagram schematic 104. Illustrating by example, one or more of the first image capture device 106, the second image capture device 125, and the third image capture device 107 can include an imager 126, a depth imager 127, and, optionally, a thermal sensor 128. Others will be obvious to those of ordinary skill in the art having the benefit of this disclosure.

In one embodiment, the imager 126 comprises a two-dimensional imager configured to receive at least one image of the subject when performing the activity. In one embodiment, the imager 126 comprises a two-dimensional Red-Green-Blue (RGB) imager. In another embodiment, the imager 126 comprises an infrared imager. Other types of imagers suitable for use as the imager 126 to capture images of the subject performing the activity will be obvious to those of ordinary skill in the art having the benefit of this disclosure.

Where included, the thermal sensor 128 can also take various forms. In one embodiment, the thermal sensor 128 is simply a proximity sensor component comprising an infrared receiver without a corresponding transmitter. In another embodiment, the thermal sensor 128 comprises a simple thermopile. In another embodiment, the thermal sensor 128 comprises an infrared imager that captures the amount of thermal energy emitted by an object. Other types of thermal sensors 128 will be obvious to those of ordinary skill in the art having the benefit of this disclosure.

Where included, the depth imager 127 can take a variety of forms. In a first embodiment, the depth imager 127 comprises a pair of imagers separated by a predetermined distance, such as three to four images. This “stereo” imager works in the same way the human eyes do in that it captures images from two different angles and reconciles the two to determine distance.

In another embodiment, the depth imager 127 employs a structured light laser. The structured light laser projects tiny light patterns that expand with distance. These patterns land on a surface, such as the body of the subject when performing the activity and are then captured by an imager. By determining the location and spacing between the elements of the pattern, three-dimensional mapping can be obtained.

In still another embodiment, the depth imager 127 comprises a time of flight device. Time of flight three-dimensional sensors emit laser or infrared pulses from a photodiode array. These pulses reflect back from a surface, such as the body of the subject when performing the activity. The time it takes for pulses to move from the photodiode array to the surface and back determines distance, from which a three-dimensional mapping of a surface can be obtained. Regardless of embodiment, the inclusion of a depth imager 127 can provide a third “z-dimension” to the x-dimension and y-dimension defining the two-dimensional image captured by the imager 126, thereby allowing for three-dimensional, and even holographic, feedback to be provided to the subject.

In addition to, or instead of the intelligent imager, one or more proximity sensors included with the other sensors 124 can determine to which side of the electronic device 100 the user is positioned when the electronic device 100 is deformed. The proximity sensors can include one or more proximity sensor components. The proximity sensors can also include one or more proximity detector components. In one embodiment, the proximity sensor components comprise only signal receivers. By contrast, the proximity detector components include a signal receiver and a corresponding signal transmitter.

In one embodiment, the proximity sensor components comprise an infrared signal receiver so as to be able to detect infrared emissions from a person. Accordingly, the proximity sensor components require no transmitter since objects disposed external to the electronic device 100 deliver emissions that are received by the infrared receiver. As no transmitter is required, each proximity sensor component can operate at a very low power level.

In one embodiment, one or more proximity detector components can each include a signal receiver and a corresponding signal transmitter. The signal transmitter can transmit a beam of infrared light that reflects from a nearby object and is received by a corresponding signal receiver. The proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one embodiment, the one or more processors 109 may generate commands or execute control operations based on information received from the various sensors 124 and other components 123, including the one or more sensors 124 operable to determine the geometric form factor of the electronic device 100, the first image capture device 106, the second image capture device 125, or other components of the electronic device. The one or more processors 109 may also generate commands or execute control operations based upon information received from a combination of these components. Moreover, the one or more processors 109 may process the received information alone or in combination with other data, such as the information stored in the memory 110.

The other sensors 124 and other components 123 may include a microphone, an earpiece speaker, a loudspeaker, key selection sensors, a touch pad sensor, a touch screen sensor, a capacitive touch sensor, and one or more switches. Touch sensors may be used to indicate whether any of the user actuation targets present on the rear display 105 are being actuated. Alternatively, touch sensors can determine if the front display 120 is being touched to determine whether fingerprint data is being delivered to the fingerprint sensor. The touch sensors can include surface and/or housing capacitive sensors in one embodiment.

The other sensors 124 and components 123 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion. In one embodiment the motion detectors are also operable to detect movement, and direction of movement, of the electronic device 100 by a user.

In one or more embodiments, the other sensors 124 and components 123 include a gravity detector. For example, as one or more accelerometers and/or gyroscopes may be used to show vertical orientation, constant, or a measurement of tilt relative to gravity. Accordingly, in one or more embodiments, the one or more processors 109 can use the gravity detector to determine an orientation of the electronic device 100 in three-dimensional space relative to the direction of gravity.

The other sensors 124 and components 123 operable with the one or more processors 109 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components and still be within the scope of the present disclosure.

Turning now to FIG. 2, illustrated therein is one explanatory method 200 for using the electronic device (100) of FIG. 1. At step 201 of FIG. 2, the one or more processors of an electronic device can determine that a group photograph will be taken in multiple stages. In one or more embodiments, this can be done using the various sensors and by analyzing various input signals and contextual data.

For instance, the processors may utilize sensor data from the device's accelerometer and gyroscope to detect a stable position indicative of a tripod setup, suggesting the intent to capture a group photo. Additionally, the processors can analyze user interactions with the device, such as selecting a “group photo” mode within the camera application or setting a timer for delayed capture, which implies the photographer's inclusion in the image.

In another use case, the device may employ facial recognition algorithms to identify multiple faces in the frame, prompting the processors to suggest a multi-stage capture process to ensure all subjects, including the photographer, are included. Furthermore, the processors can leverage location data and historical usage patterns, such as frequent group photo captures at specific locations, to predict the requirement for a multi-stage photograph. These methods, individually or in combination, enable the electronic device to intelligently determine when capturing a group photograph in multiple stages is appropriate, thereby enhancing the user experience by automating the process and reducing the need for manual adjustments.

In step 202 of FIG. 2, the method 200 comprises capturing an image depicting a first subject using an image capture device. This step 202 can be executed in various scenarios to accommodate different user needs and environmental conditions.

For instance, in a scenario where the first subject is a person, the image capture device may utilize facial recognition technology to automatically focus and adjust exposure settings, ensuring optimal image quality. Alternatively, in a setting where the first subject is an inanimate object, such as a landmark or artwork, the device may employ scene recognition algorithms to enhance specific features of the subject, such as color and texture, to produce a visually appealing image.

In another scenario, the image capture device may be configured to operate in a low-light environment, where the device can automatically adjust ISO settings and activate a night mode to capture clear and detailed images of the first subject. These scenarios illustrate the versatility of the image capture device in adapting to various conditions to effectively capture the first subject in step 202.

At decision 203, the method determines whether another person is to be added to the sequentially captured group photo by analyzing various contextual and sensor data. This decision can be made in a variety of ways.

For instance, the device may a utilize facial recognition technology from imaged captured with a rear-facing image capture device to determine whether the photographer has been depicted in the images captured to this point. The facial recognition technology may identify multiple faces within the frame, suggesting the presence of additional subjects who may need to be included in the final composition.

In another use case, the device could detect a stable position indicative of a tripod setup through accelerometer and gyroscope data, implying that the photographer intends to be part of the group photo. Additionally, user interactions such as selecting a “group photo” mode or setting a timer for delayed capture can trigger the decision to include the photographer in the image.

The device may also leverage historical usage patterns, such as frequent group photo captures at specific locations, to predict the need for a multi-stage photograph. These methods, individually or in combination, enable the electronic device to intelligently determine when capturing a group photograph in multiple stages is appropriate, thereby enhancing the user experience by automating the process and reducing the need for manual adjustments

If no additional persons are to be added, the photograph is rendered at step 204. However, where additional persons are to be added to an already captured image, the method 200 moves to step 205.

In optional step 205 of FIG. 2, the method 200 may employ a depth imager to ascertain the distance between the image capture device and the subject of a captured image. The depth imager, which can be a stereo camera, structured light sensor, or time-of-flight sensor, may function by emitting light or infrared signals that reflect off the subject and return to the sensor.

By measuring the time required for the signals to return or by analyzing the disparity between images captured from slightly different angles, the depth imager calculates the distance to the subject with high precision. This distance information is useful in accurately generating a skeletal model of a second subject, ensuring that the model is appropriately scaled and positioned relative to the first subject in the augmented image.

The use of a depth imager enhances the accuracy of the skeletal model's placement, thereby improving the overall quality and alignment of the final composite image. In one or more embodiments, step 205 determines, by one or more processors using one or more sensors while the image is being captured at step 202, a location of the first subject relative to the image capture device.

At step 207, one or more processors of the electronic device can prompt a user to take a next sequential photograph of the group image. One example of such a prompt is illustrated and described with reference to FIG. 3B below. Others will be obvious to those of ordinary skill in the art having the benefit of this disclosure.

At step 208 of FIG. 2, the method 200 generates a skeletal model to depict a second subject in a predefined position relative to the depictions of a first subject, thereby obtaining an augmented image. This skeletal model is generated by the one or more processors, which may utilize data regarding the location of the first subject relative to the image capture device at the time the first image is captured.

Illustrating by example, in one or more embodiments the size of the skeletal model is dynamically adjusted based on this location data, ensuring that the model is appropriately scaled to match the spatial context of the first subject within the captured image. By accurately determining the distance and orientation of the first subject, the system can generate a skeletal model that aligns precisely with the intended composition, facilitating seamless integration of the second subject into the augmented image. This method enhances the accuracy and aesthetic quality of the final composition by providing a visual guide for the second subject to align themselves correctly within the frame.

Step 208 can be performed in a variety of ways. In one or more embodiments, step 208 comprises generating a computer-generated model of a person executing a predefined activity. In another embodiment, the model may be simply a mapping of predefined reference locations corresponding to the subject reference locations are situated at predefined features of a subject to be depicted in one or more images, optionally performing the activity defined by the model.

In still another embodiment, the model is a geometric illustration of ideal alignments of the subject to be photographed. These examples of models are illustrative only, as numerous other examples will be obvious to those of ordinary skill in the art having the benefit of this disclosure.

In one or more embodiments, step 208 further comprises identifying, with the one or more processors, a plurality of standard reference locations situated at predefined features of a subject to be depicted in the one or more electronic images. In one or more embodiments, the plurality of standard reference locations corresponds to the plurality of subject reference locations situated at predefined features of what will become the depiction of the subject in one or more electronically captured images on a one-to-one basis.

Thus, if the identification of the subject reference locations occurring at step 208 can comprise identifying one or more predefined reference locations along the body of the subject, such as their eyes, ears, nose, neck, shoulders, elbows, hands, hips, knees, and feet. In one or more embodiments step 208 comprises identifying those same locations as the plurality of standard reference locations situated at predefined features of the model to be depicted in the one or more electronic images.

Accordingly, identification of the standard reference locations may comprise identifying eyes, ears, nose, neck, shoulders, elbows, hands, hips, knees, and feet of the depiction of the skeletal model, computer-generated standard, or other standard in the electronic images such that the standard reference locations correspond to the subject reference locations on a one-to-one basis in one or more embodiments.

Since the depictions of the already captured subject and the depictions of the to be captured subject may, absent embodiments of the disclosure, can be different in scale, location, rotational alignment, placement, size so forth, in one or more embodiments step 208 comprises performing, with the one or more processors of the electronic device, a Procrustes superimposition operation on one or both of the depiction of the subject in the captured images and/or the skeletal model generated to ensure that the size of the skeletal model and the size of the already depicted subject are similar in metrics. As such, in one or more embodiments the skeletal model generated at step 208 comprises a plurality of subject reference locations situated at predefined features of the second subject while depicted performing an activity with the first subject.

In one or more embodiments, this Procrustes superimposition operation occurring at step 208 comprises one or more of electronically translating, rotating, and scaling one or both of the depiction of the subject depicted in one or more electronically captured images and/or the skeletal model to be depicted in the one or more subsequent electronic images. Step 209 can then comprise augmenting, by one or more processors, the image to depict the skeletal model of a second subject in a predefined position relative to depictions of the first subject to obtain an augmented image. In one or more embodiments, step 209 can comprise a superimposition of either the skeletal model to be depicted in the one or more electronic images or a representation of the skeletal model to be depicted in the one or more electronic images.

In one or more embodiments, the photographer can define where the skeletal model should be positioned on the already captured image. Accordingly, in one or more embodiments step 209 comprises receiving, by a user interface, user input defining the predefined position.

In one or more embodiments, step 210 then comprises presenting, by the one or more processors on a rear facing display, the augmented image while the image capture device is in a viewfinder mode of operation. In one or more embodiments, step 211 comprises capturing, with the image capture device, another image depicting the second subject after the second subject at least partially overlaps the skeletal model being presented on the rear facing display while in the viewfinder mode of operation. In one or more embodiments, step 211 comprises capturing the other image automatically once the second subject overlaps the skeletal model being presented on the rear facing display while in the viewfinder mode of operation by a predetermined threshold amount.

In one or more embodiments, step 212 then comprises synthesizing, by the one or more processors, the image and the another image to obtain a composite image depicting the first subject and the second subject in the predefined position relative to the depictions of the first subject. The process beginning at step 205 can then repeat if others are to be added to the group photograph. In one or more embodiments, step 207 of these subsequent loops comprises presenting, by the one or more processors on a front facing display, a prompt requesting that the another image be captured while the second subject at least partially overlaps the skeletal model when the augmented image is presented on the rear facing display in the viewfinder mode of operation.

Otherwise, once all the subjects have been photographed using the process (after the first subject) found in steps 205-212, step 204 can comprise presenting, by the one or more processors on a front facing display, the composite image.

Turning ow to FIG. 3A, illustrated therein are one or more method steps initiating a method in accordance with one or more embodiments of the disclosure. Beginning at step 301, as Mac 303 and Hidey 304 strolled back home, they unexpectedly found themselves at the doorstep of the world-famous Buster's Chicken Stand 305, a culinary landmark renowned for its chicken served in eight delectable ways. The stand's reputation precedes the establishment, with dishes like the crispy Southern-fried chicken, tangy lemon-pepper wings, and the spicy Cajun grilled chicken, each offering a distinct taste experience that has captivated patrons for generations. The irresistible aroma of Buster's signature honey-glazed drumsticks wafted through the air, likely guiding Mac 303 and Hidey 304 to this iconic eatery, just as the aroma has drawn countless others over the years.

Enthralled by the moment, at step 301 Mac 303 proposes they capture the memory with a group photo beside the legendary stand. However, Hidey 304 hesitates, pointing out the absence of anyone to assist them with the photo. Indeed, she exclaims, “But there's nobody here to help us!” Hidey 304, having only experienced prior art electronic devices, simply presumes that they will need to find a bystander to take their collective photo or suffer with a poorly framed “selfie” due to the short length of Mac's arms. Fortunately, Mac 303 was prepared with an electronic device 300, ingeniously configured in accordance with embodiments of the disclosure, enabling them to take an ideal group photo without needing a third party, thus preserving their visit to Buster's Chicken Stand 305 in a memorable picture.

At step 201, the one or more processors of the electronic device 300 can determine that a group photograph will be taken in multiple stages. This step 201 can be performed by employing a variety of techniques that enhance user experience and ensure optimal image composition.

One technique suitable for step 201 involves utilizing sensor data from the device's accelerometer and gyroscope to detect a stable position indicative of a tripod setup, which suggests the intent to capture a group photo. This technique is advantageous as it allows the device to automatically recognize the need for a multi-stage capture without user intervention.

Another technique suitable for step 201 includes analyzing user interactions with the device, such as selecting a “group photo” mode within the camera application or setting a timer for delayed capture, which implies the photographer's inclusion in the image. This approach provides flexibility and control to the user, allowing them to customize their photo-taking experience.

Additionally, at step 201 the electronic device 300 may employ facial recognition algorithms, using both the front-facing imager and rear-facing imager, to identify multiple faces in the respective frames. The one or more processors may then present a prompt to suggest a multi-stage capture process to ensure all subjects, including the photographer, are included. This technique is beneficial as it leverages advanced image processing capabilities to automatically adjust the capture process based on the detected number of subjects.

Furthermore, in other embodiments the processors can leverage location data and historical usage patterns at step 201, such as frequent group photo captures at specific locations, to predict the requirement for a multi-stage photograph. These methods, individually or in combination, enable the electronic device to intelligently determine when capturing a group photograph in multiple stages is appropriate, thereby enhancing the user experience by automating the process and reducing the need for manual adjustments.

At step 302, Mac 303 is using the electronic device electronic device 300 configured in accordance with one or more embodiments of the disclosure to capture at least one image 306 of a subject, which is Hidey 304. More specifically, the Mac 303 is using the front-facing imager of the electronic device 100 to capture the at least one image 306 of Hidey 304. The at least one image 306 could be a single static image, a series of burst images, a video stream, or other set of successively captured images.

In this illustrative embodiment, the electronic device 300 is a deformable electronic device in that the first device housing 307 can be pivoted relative to the second device housing 308 about a hinge 309 between a closed position, shown at step 301, and an axially displaced open position shown at step 302. At step 302, the mac 303 has pivoted the first device housing 307 relative to the second device housing 308 to the axially displaced open position.

When this occurs, in one or more embodiments one or more sensors and/or flex sensors of the electronic device 300 detect the geometric form factor of the electronic device 300 exposing the rear-facing display and rear-facing imager. It should be noted that the front-facing imager and front facing display are exposed in both the axially displaced open position and closed position.

Additionally, at step 302 Mac 303 has launched an image capture application by delivering touch input to the rear-facing display. In one or more embodiments, this user input designates not only that one or more images will be captured, but that a group image taken in multiple stages will be captured. Additionally, this user input actuates the front-facing imager and allows the Mac 303 to see image content depicting the Hidey 304 by Buster's Chicken Stand 305 in the form of imager viewfinder content on the rear-facing display until he delivers additional user input to the rear-facing display initiating an image capture operation causing the at least one image 306 of the subject to be captured and stored non-transitorily in the memory of the electronic device 300.

In one or more embodiments, the imager viewfinder content comprises a stream of images sensed by the sensor of the front-facing imager and presented on one or more displays while the front-facing imager is actuated. In one or more embodiments, the imager viewfinder content is not stored in the memory other than in a transitory manner allowing presentation on those display(s).

Image capture operations performed at step 302 can include operations such as actuating an imager, launching an imager application, directing the lens of an imager toward a subject that they wish to photograph, and delivering user input causing an imager to one or more of actuate, capture light, focus on an object or scene, emit light from a flash, and/or capture one or more images. Other examples of image capture operations include the actuation of facial recognition algorithms that employ an imager to analyze light received in its field of view to identify various characteristics of a subject or scene. Still other examples of image capture operations will be obvious to those of ordinary skill in the art having the benefit of this disclosure.

As previously described, step 202 comprises capturing, with an image capture device, at least one image 306 depicting a first subject. Turning now to FIG. 3B, such an image 310 depicting Hidey 304 is shown.

In one or more embodiments, step 205 also comprises the one or more processors of the electronic device 300 using one or more sensors to determine a distance (shown as the arrowed line between Hidey 304 and the image capture device of FIG. 3A) between the subject, who is Hidey 304 in this example, and the image capture device capturing the image 310. Said differently, step 205, which could have been performed at step (302) of FIG. 3A, can comprise one or more processors of the electronic device 300 utilizing one or more sensors to determine the distance between Hidey 304 and the image capture device capturing the image 310 of Hidey 304. This distance determination can be achieved through various techniques, each offering distinct advantages. Still others will be obvious to those of ordinary skill in the art having the benefit of this disclosure.

Illustrating by example, one technique available at step 205 involves the use of a stereo camera system, which captures images from slightly different angles and calculates the distance based on the disparity between these images, providing high precision and accuracy. Another technique employs a structured light sensor, which projects a pattern of light onto Hidey 304 and measures the deformation of the pattern to ascertain distance, offering robustness in various lighting conditions.

Additionally, a time-of-flight sensor can be used at step 206, which emits light pulses and measures the time taken for the pulses to return after reflecting off Hidey 304, allowing for rapid and accurate distance measurement. These techniques enable the electronic device 300 to accurately scale and position the skeletal model relative to Hidey 304, enhancing the quality and alignment of the final composite image.

At step 207 of FIG. 3B, the electronic device 300 prompts the photographer to capture the next subsequent photograph in a group photograph taken in multiple stages. This prompt 318, one example of which is shown at step 311, can be delivered through various methods, each offering distinct advantages.

For instance, in one or more embodiments the electronic device 300 may display a visual cue on the rear-facing display as shown at step 311. In one or more embodiments, the visual cue can include a flashing icon or a highlighted button, indicating that the next stage of the photograph is ready to be captured. This visual prompt is advantageous as it provides a clear and immediate signal to the photographer, reducing the likelihood of missed or delayed captures.

Alternatively, the electronic device 300 may emit an audible alert, such as a beep or a spoken instruction, which can be beneficial in situations where the photographer is not directly looking at the display, ensuring awareness of the next step without needing to divert attention. Additionally, the electronic device 300 may utilize haptic feedback, such as a vibration, to notify the photographer, which is particularly useful in noisy environments where visual and audible cues might be less effective. These prompting methods performed at step 207 enhance the user experience by providing flexible and reliable notifications, ensuring that each stage of the group photograph is captured accurately and efficiently.

In step 208 of FIG. 3B, the one or more processors of the electronic device 300 generate a skeletal model 314 of a second subject positioned at a predefined orientation relative to depictions of the first subject. One example of such a skeletal model 314 is shown at step 312.

In one or more embodiments, the one or more processors of the electronic device 300 generate a skeletal model 314 of a second subject positioned at a predefined orientation relative to depictions of the first subject utilizing the distance between the first subject and the image capture device as an important parameter. In one or more embodiments, this process begins by capturing the spatial data of the first subject through depth sensors, which allows the processors to accurately scale and position the skeletal model.

For example, if the first subject is standing two meters away, the skeletal model 314 is adjusted to reflect this distance, ensuring proportionality and alignment within the augmented image. Another example involves the use of stereo cameras to capture depth information, which enables the processors to create a two-dimensional skeletal model 314 that aligns with the spatial context of the first subject. This method provides significant advantages, such as enhancing the accuracy of the skeletal model's placement, thereby improving the overall quality and alignment of the final composite image. Additionally, by dynamically adjusting the skeletal model 314 based on real-time distance measurements, the system facilitates seamless integration of the second subject into the composition, reducing the need for manual adjustments and ensuring a more intuitive user experience.

In step 209 of FIG. 3B, the one or more processors superimpose the skeletal model 314 on the image to obtain an altered image 313. In one or more embodiments, the one or more processors utilize various techniques to enhance the accuracy and user experience.

One example involves the use of augmented reality (AR) technology, where the skeletal model 314 is dynamically overlaid onto the live camera feed, allowing users to see real-time adjustments as they align themselves with the model. This method provides immediate visual feedback, reducing the need for trial-and-error positioning and ensuring precise alignment.

Another approach employs depth-sensing technology, which uses data from stereo cameras or time-of-flight sensors to accurately position the skeletal model 314 in three-dimensional space relative to the first subject. This technique ensures that the model is correctly scaled and oriented, enhancing the realism and effectiveness of the visual guide.

Additionally, the processors may utilize machine learning algorithms to predict optimal placement of the skeletal model 314 in the augmented image based on historical data and user preferences, offering a personalized experience that adapts to individual user behavior. Each of these methods offers distinct advantages, such as improved accuracy, enhanced user interaction, and the ability to create aesthetically pleasing compositions with minimal effort.

In step 210, the one or more processors of the electronic device 300 are configured to cause a display 315 positioned adjacent to the image capture device 316 to present the altered image 313. In one or more embodiments, this process involves the processors executing stored program instructions that control the display to render the augmented image in real-time.

In one or more embodiments, the altered image 313, which includes the superimposed skeletal model 314 of a second subject, is displayed on the screen to provide immediate visual feedback to the user. This configuration allows the user to view the augmented image as the subsequent image is being captured, facilitating precise alignment of the subjects within the frame. The display 315, being positioned adjacent to the image capture device 316, ensures that the user can easily monitor the composition while adjusting their position or the position of other subjects relative to the skeletal model 314. This real-time presentation of the altered image 313 enhances the user's ability to achieve the desired composition, thereby improving the overall quality of the captured images.

In one or more embodiments, at step 210 of FIG. 3B the one or more processors are also configured to cause viewfinder content 317 to be presented with the altered image 313 when a second subject is positioned within the field of view of the image capture device 316. This configuration allows the second subject to concurrently see themselves in both the viewfinder content 317 and the altered image 313, facilitating precise alignment with the skeletal model.

For example, the viewfinder content 317 can be synthesized with the altered image 313 by overlaying a live video feed of the second subject onto the augmented image, providing real-time feedback and enabling the subject to adjust their position dynamically. Another example involves using a split-screen approach, where one portion of the display shows the live viewfinder content 317 and another portion displays the altered image 313, allowing the subject to compare their current position with the desired alignment. This method is advantageous as it offers a clear visual guide, reducing the need for trial-and-error adjustments and enhancing the accuracy of the final composition.

Additionally, the processors can employ augmented reality techniques to highlight areas of misalignment between the second subject and the skeletal model, further aiding in achieving the desired positioning. These approaches collectively improve the user experience by streamlining the process of capturing well-composed group photographs

Turning now to FIG. 3C, at step 211 the one or more processors of the electronic device 300 are configured to capture another image 323 depicting the second subject while the second subject is at least substantially in the predefined orientation. In one or more embodiments, this process involves utilizing the image capture device 316 to detect when the second subject aligns with the skeletal model presented on the display.

At step 320 of FIG. 3C, the display 315, positioned adjacent to the image capture device 316, presents synthesized content 322. In one or more embodiments, the synthesized content 322 comprises both the altered image 313 and the viewfinder content 317. This configuration is designed to facilitate the alignment of the second subject with the skeletal model 314.

The altered image 313, which incorporates the skeletal model 314, serves as a visual guide for the second subject, providing a reference for precise positioning within the frame. Concurrently, the viewfinder content 317 offers a real-time video feed of the second subject, allowing them to see their current position relative to the skeletal model 314. By integrating these two elements, the display 315 enables the second subject to make necessary adjustments to their posture and location, ensuring accurate alignment with the skeletal model 314. This dual presentation of synthesized content 322 enhances the user's ability to achieve the desired composition, thereby improving the overall quality and accuracy of the captured group photograph.

Once the alignment is detected, the processors automatically trigger the capture of the second image. In one or more embodiments, this is done automatically. In other embodiments, a photographer can watch, using the rear facing display, for the second subject to sufficiently align to their liking.

In the illustrative embodiment of FIG. 3C, at step 321 Hidey 304 is merely holding the electronic device 300 while waiting for Mac 303 to sufficiently align with the skeletal model 314. Once he does, one or more processors of the electronic device 300 automatically capture a second image.

Turning now to FIG. 3D, at step 212, subsequently, the processors synthesize this newly captured image with the previously captured image of the first subject to form a composite image 330. In one or more embodiments, this synthesis process involves combining the two images to create a composite image 330 that accurately depicts both the first and second subjects in the desired composition.

The synthesis ensures that the spatial relationship between the subjects is maintained, resulting in a seamless and aesthetically pleasing group photograph. This method effectively addresses the challenges of aligning multiple compositions by leveraging the capabilities of the electronic device's multi-display and depth-sensing technologies.

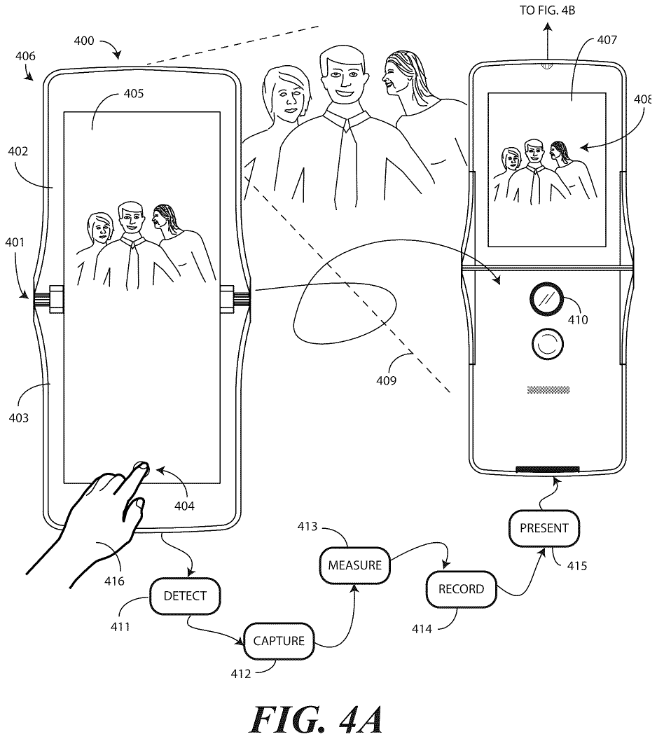

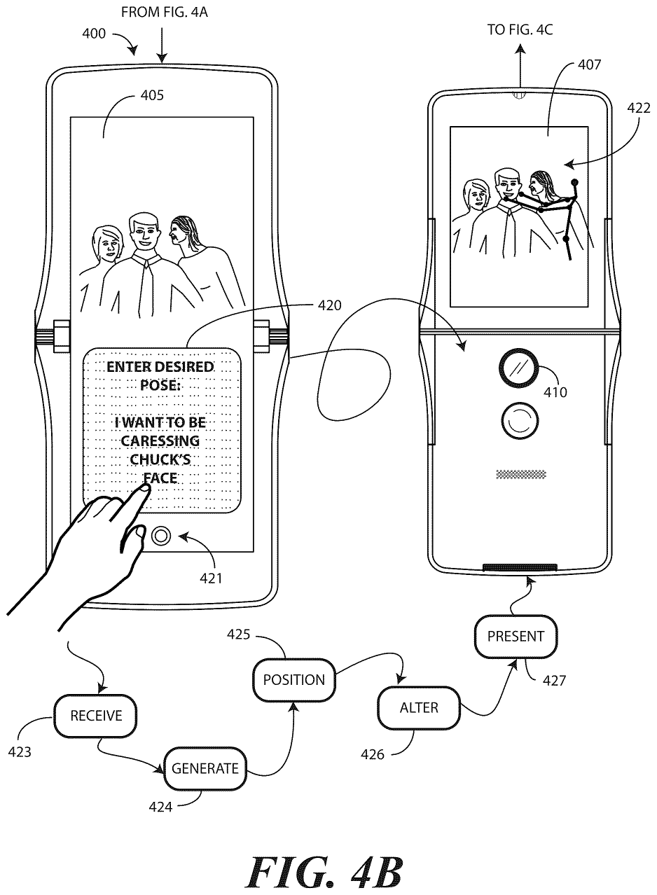

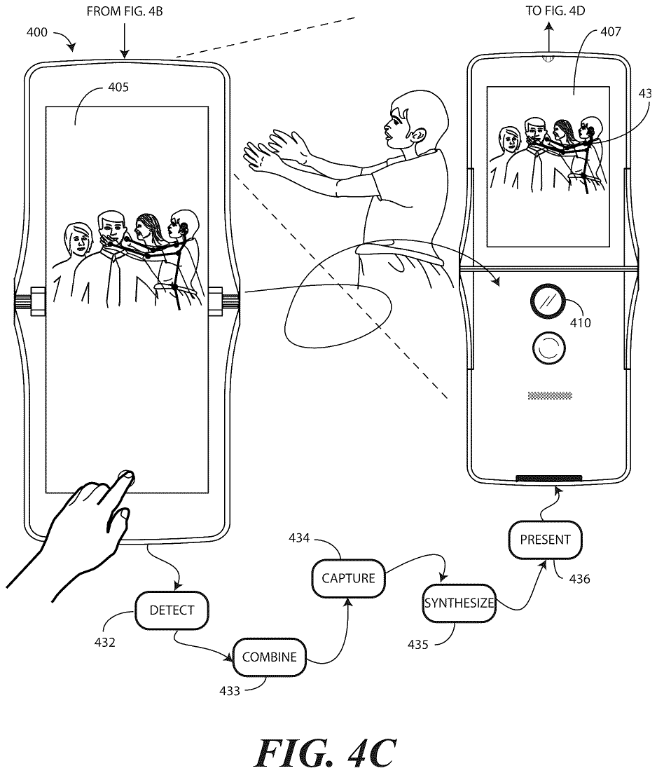

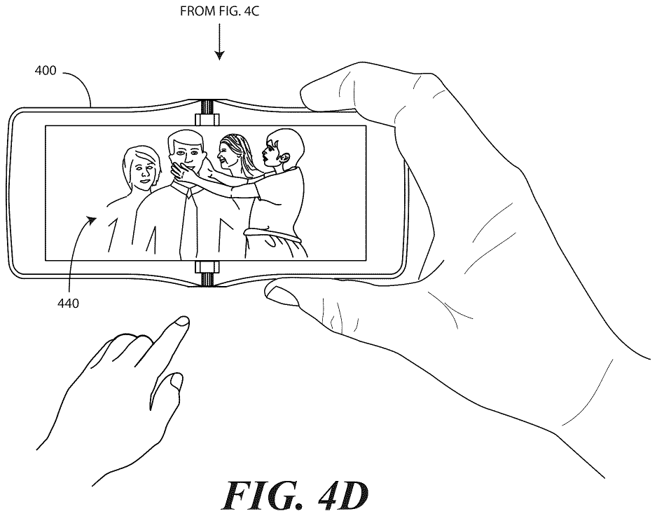

Turning now to FIG. 4A, illustrated therein are one or more method steps associated with another method in accordance with one or more embodiments of the disclosure. As shown, a photographer 416 is delivering user input 404 to an electronic device 400 having a first housing portion 402 that is pivotable about a hinge 401 relative to a second housing portion 403 between a closed position concealing a first display 405 while leaving an image capture device 410 and a second display exposed 407 and an axially displaced open position 406 where each of the image capture device 410, the first display 405, and the second display 407 are exposed to capture a group image in multiple stages. The image capture device 410 has a field of view 409. As with the electronic device (100) of FIG. 1, the electronic device 400 of FIG. 4 comprises one or more processors that are operable with the image capture device 410.

In one or more embodiments, the one or more processors, upon the image capture device 410 capturing an image 408 depicting a first subject, augment the image 408 with a model defined by reference locations situated at predefined features of a second subject at a position relative to depictions of the first subject to obtain an augmented image and cause the second display 407 to present the augmented image while the image capture device 410 is in a viewfinder mode of operation.

In step 411 of FIG. 4A, the electronic device 400 employs a combination of sensor data analysis and user input recognition to determine that image 408 is part of a series of images intended for a composite group image. Illustrating by example, the electronic device 400 can utilize onboard sensors, such as accelerometers and gyroscopes, to detect a stable positioning indicative of a tripod setup or similar arrangement, suggesting the intent to capture multiple images for a group composition. Additionally, the device's processors might analyze user interactions, such as selecting a “group photo” mode or setting a timer, which implies the photographer's inclusion in the sequence of images.

The system may also employ facial recognition algorithms to identify multiple faces within the frame, prompting the device to recognize the need for a multi-stage capture process. By leveraging these techniques, the electronic device intelligently identifies when an image is part of a composite group photo sequence, thereby enhancing the user experience by automating the process and reducing the need for manual adjustments.

At step 412, the image capture device 410 captured an image 408 depicting at least a first subject positioned within the field of view 409 of the image capture device 410 in response to the user input 404. In step 413 of FIG. 4A, the electronic device utilizes one or more processors in conjunction with one or more sensors to determine the location of the first subject relative to the image capture device while the image is being captured.

In one or more embodiments, this process involves the integration of depth-sensing technology, such as a stereo camera system, structured light sensor, or time-of-flight sensor, which emits light or infrared signals that reflect off the subject and return to the sensor. By measuring the time taken for these signals to return or by analyzing the disparity between images captured from slightly different angles, the system calculates the distance to the subject with high precision. This distance information is important for accurately generating a skeletal model of a second subject, ensuring that the model is appropriately scaled and positioned relative to the first subject in the augmented image. The use of such depth-sensing technology enhances the accuracy of the skeletal model's placement, thereby improving the overall quality and alignment of the final composite image. The distance can be recorded at step 414.

At step 415 of FIG. 4A, the image 408 depicting at least one subject can optionally be presented on the second display 407. This feature allows the individuals depicted in the first image of the sequential set of images, which will be used to create a group image, to review their poses, hair, and optionally makeup.

Additionally, by displaying the captured image on the second display 407, users can ensure that their appearance and positioning meet their expectations before proceeding with the subsequent stages of the group photo composition. This capability enhances the user experience by providing immediate feedback, allowing for adjustments to be made in real-time, thereby improving the overall quality and satisfaction with the final composite image. The second display 407, being outward facing, offers a convenient and accessible means for subjects to verify their appearance without needing to reposition the device or rely on external assistance

Turning now to FIG. 4B, in one or more embodiments the electronic device 400 is configured such that one or more processors can present a prompt 420 on the first display 405. In one or more embodiments, this prompt 420 requests that another image be captured while the second subject at least partially overlaps the skeletal model, which is displayed on the rear-facing display in the viewfinder mode of operation.

The prompt 420 serves as a visual cue to the user, indicating the optimal moment to capture the subsequent image for accurate alignment within the composite photograph. Upon presentation of the prompt 420, step 423 involves receiving user input 421, which may be in the form of a touch, gesture, or other interaction with the device. This user input 421 initiates the skeletal model generation process, allowing the processors to dynamically adjust the model based on the current positioning of the second subject relative to the first subject. This process ensures that the skeletal model is accurately scaled and positioned, facilitating precise alignment and enhancing the overall quality of the final composite image.

In step 424 of FIG. 4B, the electronic device 400 generates a skeletal model of a second subject, which is optionally based on the distance measured in FIG. 4A. In one or more embodiments, this process involves utilizing the depth-sensing capabilities of the device, such as a stereo camera system or a time-of-flight sensor, to accurately determine the spatial relationship between the first subject and the image capture device. The distance data obtained from FIG. 4A can be used to scale and position the skeletal model appropriately, thereby ensuring alignment with the spatial context of the first subject within the captured image.

By dynamically adjusting the skeletal model based on real-time distance measurements, the system facilitates precise alignment of the second subject within the augmented image, thereby enhancing the accuracy and aesthetic quality of the final composite photograph. This method reduces the need for manual adjustments and provides a seamless user experience by allowing the second subject to align themselves accurately with the skeletal model, ensuring a well-composed group image.

In step 425 of FIG. 4B, the augmentation process involves the one or more processors utilizing depth-sensing data and image processing algorithms to superimpose a skeletal model of a second subject onto the first image. This skeletal model is generated based on predefined reference points that correspond to significant anatomical features, such as joints and limbs, of the second subject. The processors calculate the spatial relationship between the first subject and the image capture device, using this information to accurately scale and position the skeletal model within the frame.

By aligning the skeletal model with the first subject's depiction at step 426, the system ensures that the second subject can be seamlessly integrated into the composition by creating an augmented image 422. This augmentation provides a visual guide for the second subject, allowing them to align themselves accurately with the skeletal model, thereby facilitating the creation of a well-composed group photograph. The augmented image is then presented on the display, enabling real-time adjustments and ensuring that the final composition meets the desired aesthetic criteria.

In step 427, the augmented image 422, which includes the skeletal model, is presented on the second display 407 of the electronic device 400. This configuration allows the second display, which is outwardly facing, to serve as a visual guide for the second subject, enabling them to align themselves accurately with the skeletal model. It should be noted that while the skeletal model appears to be reaching behind the head of a subject, in some embodiments there may be truncations or other alterations for a model that includes depictions behind someone who has already been photographed.

Regardless, by presenting the augmented image 422 on the second display 407, users can easily see the intended composition and make necessary adjustments to their position in real-time, without needing to rely on external assistance or guesswork. This method significantly enhances the accuracy and efficiency of capturing group photographs, as it provides immediate feedback and reduces the need for trial-and-error positioning. The use of the second display in this manner leverages the dual-display capabilities of the device, offering a seamless and intuitive user experience that improves the overall quality of the final composite image

Turning now to FIG. 4C, in step 432 of FIG. 4C the detection of a second subject entering the field of view of the image capture device 410 is facilitated by the integration of advanced sensor technology and image processing algorithms. The electronic device 400 employs a combination of proximity sensors and intelligent imaging systems to continuously monitor the area within the field of view.

As the augmented image is presented on the second display 407, the system utilizes real-time data from these sensors to identify the presence of a second subject. The proximity sensors, which may include infrared or ultrasonic components, detect changes in distance and movement, while the intelligent imaging system employs facial recognition and motion detection algorithms to confirm the presence of a human subject. This dual-layered approach ensures that the system accurately identifies when a second subject enters the frame, allowing for seamless integration into the augmented image and facilitating the subsequent capture of a well-composed group photograph.

In step 433, the electronic device 400 combines viewfinder content with the augmented image to facilitate the alignment of an additional subject with previously photographed individuals depicted in the augmented image. This process involves the integration of real-time viewfinder content 431, which provides a live video feed of the additional subject, with the augmented image that includes the skeletal model and depictions of the first subject.

The second display 407, being outwardly facing, presents this synthesized content, allowing the additional subject to visually align themselves with the skeletal model and the depictions of the first subject. By observing the second display 407, the additional subject can make necessary adjustments to their position and orientation, ensuring precise alignment with the augmented image. This method enhances the accuracy and efficiency of capturing group photographs by providing immediate visual feedback, reducing the need for trial-and-error positioning, and ensuring that the final composition is aesthetically pleasing and well-aligned.

Step 434 involves capturing another image with the image capture device, depicting the second subject after the second subject at least partially overlaps the skeletal model being presented on the second display 407 while in the viewfinder mode of operation. In this illustrative example, the capturing at step 434 occurs automatically once the second subject overlaps the skeletal model being presented on the front-facing display by a predetermined threshold amount.

This threshold amount can be defined as a percentage of overlap between the second subject and the skeletal model, such as seventy percent, eighty percent, or ninety percent, depending on the desired precision of alignment. The threshold amount might be determined based on user preferences, which can be set through the device's user interface, or it can be dynamically adjusted by the system based on environmental conditions, such as lighting or the complexity of the background. For instance, in a well-lit environment with a simple background, a higher threshold might be used to ensure precise alignment, whereas in a dimly lit or cluttered setting, a lower threshold might be more appropriate to accommodate potential variations in subject positioning.

In step 435, the method involves synthesizing, by the one or more processors, the image and the another image to obtain a composite image that accurately depicts both the first subject and the second subject in the predefined position relative to the depictions of the first subject. An example of this synthesized image 440 is being presented on the electronic device in FIG. 4D in response to the presentation operation occurring at step 436.

In one or more embodiments, this synthesis process utilizes advanced image processing algorithms to seamlessly merge the two images, ensuring that the spatial relationship between the subjects is maintained and that the final composition appears natural and cohesive. The processors analyze reference points and features within each image to align the subjects precisely, taking into account any variations in lighting, perspective, or scale that may exist between the images. By doing so, the method effectively addresses potential discrepancies that could arise from capturing the images at different times or under different conditions, thereby enhancing the aesthetic quality and accuracy of the composite image. This approach not only improves the visual appeal of the group photograph but also ensures that the subjects are depicted in a manner that meets the user's expectations for alignment and composition.

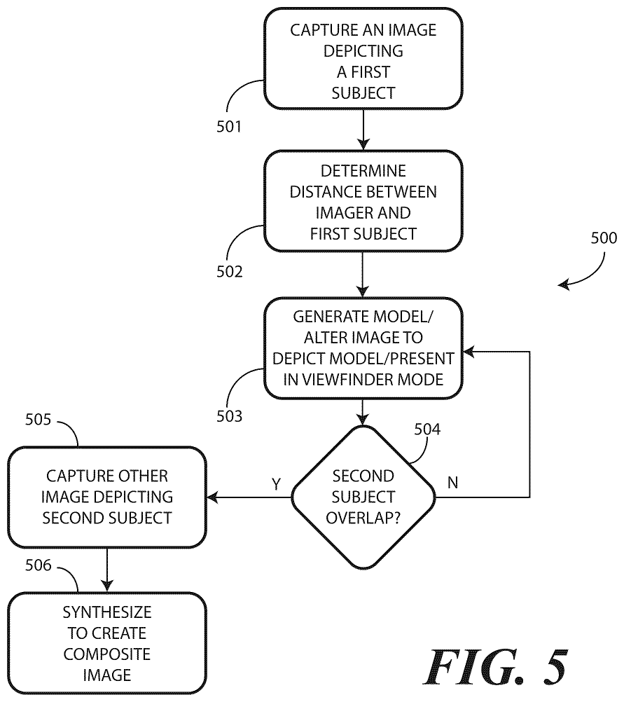

Turning now to FIG. 5, illustrated therein is another illustrative method 500 in accordance with one or more embodiments of the disclosure. In one or more embodiments, the method 500 begins with step 501, which involves capturing an image depicting a first subject. This step lays the foundation for the subsequent stages of the method 500.

The image capture device, which can be a camera integrated into a multi-display electronic device, is used to capture the initial image. This device is equipped with advanced imaging capabilities to ensure high-quality image capture, even in varying lighting conditions. The captured image serves as the baseline for further processing and augmentation, allowing the system to accurately position additional subjects in the final composite image.

Following the initial image capture, step 502 involves determining the distance between the imager and the first subject. This optional step 502 is beneficial for accurately scaling and positioning the skeletal model of the second subject in relation to the first subject. The system utilizes one or more sensors, such as a depth imager, to measure the distance with precision. This distance data is then used to adjust the size and orientation of the skeletal model, ensuring that the model aligns correctly with the spatial context of the first subject within the captured image. The accurate determination of distance is important for achieving a seamless integration of multiple subjects in the final composition.

In step 503, the method involves generating a model or altering the image to depict the model, which is then presented in viewfinder mode. The one or more processors of the electronic device are responsible for generating a skeletal model of a second subject. This model is positioned at a predefined orientation relative to depictions of the first subject, as a function of the distance between the first subject and the image capture device. The skeletal model serves as a visual guide for the second subject, allowing them to align themselves accurately within the frame. The altered image, which includes the superimposed skeletal model, is presented on a display positioned adjacent to the image capture device, providing real-time feedback to the user.

Decision 504 involves determining whether the second subject overlaps with the skeletal model. This decision point is important for ensuring that the second subject is correctly positioned before capturing the next image. The system continuously monitors the alignment of the second subject with the skeletal model using real-time data from the image capture device. If the second subject sufficiently overlaps with the model, the process proceeds to the next step. This step ensures that the final composition is aesthetically pleasing and accurately represents the intended arrangement of subjects.

Once the second subject is properly aligned, step 505 involves capturing another image depicting the second subject. This image is captured while the second subject is at least substantially in the predefined orientation, as indicated by their overlap with the skeletal model. The image capture device automatically captures the image once the alignment criteria are met, reducing the need for manual intervention. This step plays an important role in ensuring that the second subject is accurately represented in the final composite image.

Step 506 involves synthesizing the captured images to create a composite image. The one or more processors of the electronic device are responsible for combining the images of the first and second subjects to obtain a composite image depicting both subjects in the predefined position relative to each other. This synthesis process utilizes advanced image processing algorithms to seamlessly merge the images, ensuring that the spatial relationship between the subjects is maintained. The resulting composite image is then presented on a display, providing the user with a high-quality representation of the group photograph.

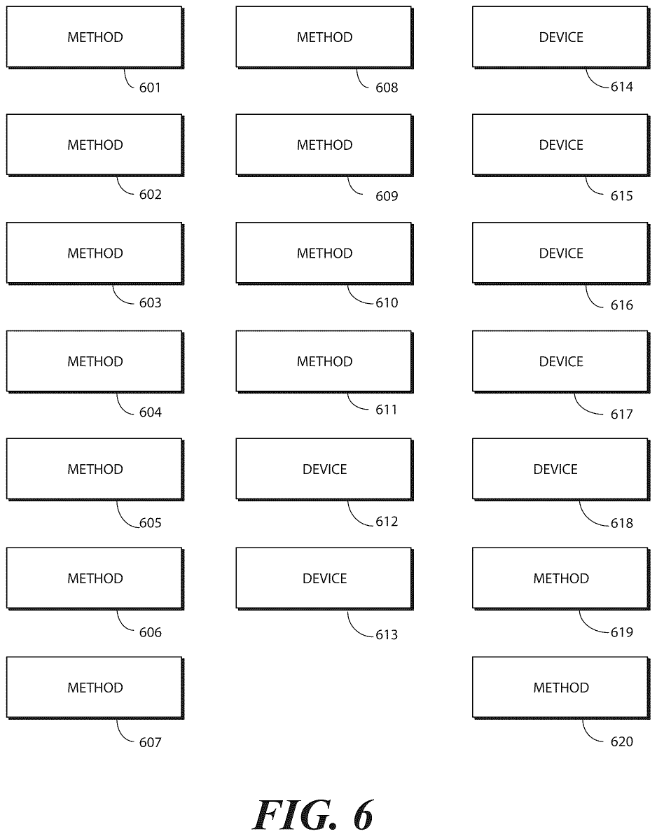

Turning now to FIG. 6, illustrated therein are various embodiments of the disclosure. The embodiments of FIG. 6 are shown as labeled boxes in FIG. 6 due to the fact that the individual components of these embodiments have been illustrated in detail in FIGS. 1-5, which precede FIG. 6. Accordingly, since these items have previously been illustrated and described, their repeated illustration is no longer essential for a proper understanding of these embodiments. Thus, the embodiments are shown as labeled boxes.

At 601, a method in an electronic device comprises capturing, with an image capture device, an image depicting a first subject. At 601, the method comprises augmenting, by one or more processors, the image to depict a skeletal model of a second subject in a predefined position relative to depictions of the first subject to obtain an augmented image. At 601, the method comprises presenting, by the one or more processors on a rear facing display, the augmented image while the image capture device is in a viewfinder mode of operation.

At 602, the method of 601 further comprises capturing, with the image capture device, another image depicting the second subject after the second subject at least partially overlaps the skeletal model being presented on the rear facing display while in the viewfinder mode of operation. At 603, the capturing of 602 automatically once the second subject overlaps the skeletal model being presented on the rear facing display while in the viewfinder mode of operation by a predetermined threshold amount.

At 604, the method of 602 further comprises determining, by one or more processors using one or more sensors while the image is being captured, a location of the first subject relative to the image capture device. At 605, the skeletal model of 604 is generated by the one or more processors as a function of the location.

At 606, the method of 605 further comprises synthesizing, by the one or more processors, the image and the another image to obtain a composite image depicting the first subject and the second subject in the predefined position relative to the depictions of the first subject. At 607, the method of 606 further comprises presenting, by the one or more processors on a front facing display, the composite image.

At 608, the method of 607 further comprises presenting, by the one or more processors on a front facing display, a prompt requesting that the another image be captured while the second subject at least partially overlaps the skeletal model when the augmented image is presented on the rear facing display in the viewfinder mode of operation. At 609, the location of the first subject of 608 relative to the image capture device is determined using a depth imager.

At 610, the method of 601 further comprises receiving, by a user interface, user input defining the predefined position. At 6 comprises a plurality of subject reference locations situated at predefined features of the second subject while depicted performing an activity with the first subject.

At 612, an electronic device comprises a first housing portion that is pivotable relative to a second housing portion between a closed position concealing a first display while leaving an image capture device and a second display exposed and an axially displaced open position where each of the image capture device, the first display, and the second display are exposed. At 612, the electronic device comprises one or more processors operable with the image capture device.

At 612, the one or more processors, upon the image capture device capturing an image depicting a first subject, augment the image with a model defined by reference locations situated at predefined features of a second subject at a position relative to depictions of the first subject to obtain an augmented image and cause the first display to present the augmented image while the image capture device is in a viewfinder mode of operation.

At 613, the one or more processors of 612 are further configured to present at least portions of viewfinder image content depicting a second subject with the augmented image while the image capture device is in the viewfinder mode of operation when the second subject is within a field of view of the image capture device. At 614, the one or more processors of 613 cause the image capture device to capture another image once the at least portions of the viewfinder image content depict the second subject overlapping the model by a predefined overlapping amount.

At 615, the one or more processors of 614 further synthesize the image and the another image to obtain a composite image depicting the first subject and the second subject at the position relative to the depictions of the first subject. At 616, the one or more processors of 615 augment the image by superimposing the model on the image.

At 617, the electronic device of 615 further comprises a depth imager. At 617, a size of the model is a function of a distance the first subject is from the image capture device when the image is captured.

At 618, the image of 615 further depicts an inanimate object in addition to the first subject. At 618, a size of the model is a function of a size of depictions of the first subject in comparison to a size of depictions of the inanimate object.

At 619, a method in an electronic device comprises capturing, with an image capture device, an image depicting a first subject. At 619, the method comprises determining, by one or more processors using one or more sensors of the electronic device, a distance between the first subject and the image capture device.

At 619, the method comprises generating, by the one or more processors, a skeletal model of a second subject positioned at a predefined orientation relative to depictions of the first subject as a function of the distance between the first subject and the image capture device. At 619, the method comprises superimposing, by the one or more processors, the skeletal model on the image to obtain an altered image.

At 619, the method comprises causing, by the one or more processors, a display positioned adjacent to the image capture device to present the altered image. At 619, the method comprises causing, by the one or more processors, viewfinder content to be presented with the altered image when a second subject is positioned within a field of view of the image capture device.

At 620, the method of 619 further comprises capturing another image depicting the second subject while at least substantially in the predefined orientation and synthesizing the another image with the image to depict the second subject and the first subject.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in various embodiments of the electronic device, the first housing portion is pivotable relative to the second housing portion, allowing the device to transition between a closed position and an axially displaced open position. In the closed position, the first display is concealed, while the image capture device and a second display remain exposed, facilitating quick access to important functions without fully opening the device. This configuration is advantageous for users who require immediate access to the camera and secondary display for notifications or quick interactions.

In the open position, all components, including the image capture device, the first display, and the second display, are exposed, enabling full functionality and providing a larger workspace for more complex tasks. The one or more processors, operable with the image capture device, enhance the device's capabilities by augmenting captured images with a model defined by reference locations at predefined features of a second subject.

This augmentation occurs in relation to the first subject, resulting in an augmented image that is presented on the first display while the device is in viewfinder mode. The distinctions between these embodiments lie in the user interaction and accessibility; the closed position offers convenience and efficiency for quick tasks, while the open position provides a comprehensive interface for detailed operations. The pivotable design thus optimizes the use of both displays, enhancing user experience by allowing seamless transitions between different operational modes and improving the overall photographic and interactive capabilities of the device.

The distinctions between these embodiments lie in the user interaction and accessibility; the closed position offers convenience and efficiency for quick tasks, while the open position provides a comprehensive interface for detailed operations. The pivotable design thus optimizes the use of both displays, enhancing user experience by allowing seamless transitions between different operational modes and improving the overall photographic and interactive capabilities of the device. Additionally, the ability of the processors to augment images with a skeletal model of a second subject provides a visual guide for precise alignment, thereby improving the quality of group photographs. This feature reduces the need for manual adjustments and trial-and-error positioning, enhancing the efficiency and accuracy of capturing group images. The dual-display setup, combined with the pivotable housing, offers a versatile platform for capturing and viewing images, addressing common challenges in mobile photography, such as misalignment and the need for manual adjustments.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
capturing, with an image capture device, an image depicting a first subject;
augmenting, by one or more processors, the image to depict a skeletal model of a second subject in a predefined position relative to depictions of the first subject to obtain an augmented image; and
presenting, by the one or more processors on a front facing display, the augmented image while the image capture device is in a viewfinder mode of operation.

2. The method of claim 1, further comprising capturing, with the image capture device, another image depicting the second subject after the second subject at least partially overlaps the skeletal model being presented on the front facing display while in the viewfinder mode of operation.

3. The method of claim 2, wherein the capturing occurs automatically once the second subject overlaps the skeletal model being presented on the front facing display while in the viewfinder mode of operation by a predetermined threshold amount.

4. The method of claim 2, further comprising determining, by one or more processors using one or more sensors while the image is being captured, a location of the first subject relative to the image capture device.

5. The method of claim 4, wherein the skeletal model is generated by the one or more processors as a function of the location.

6. The method of claim 5, further comprising synthesizing, by the one or more processors, the image and the another image to obtain a composite image depicting the first subject and the second subject in the predefined position relative to the depictions of the first subject.

7. The method of claim 6, further comprising presenting, by the one or more processors on a rear facing display, the composite image.

8. The method of claim 7, further comprising presenting, by the one or more processors on the rear facing display, a prompt requesting that the another image be captured while the second subject at least partially overlaps the skeletal model when the augmented image is presented on the front facing display in the viewfinder mode of operation.

9. The method of claim 8, wherein the location of the first subject relative to the image capture device is determined using a depth imager.

10. The method of claim 1, further comprising receiving, by a user interface, user input defining the predefined position.

11. The method of claim 1, wherein the skeletal model comprises a plurality of subject reference locations situated at predefined features of the second subject while depicted performing an activity with the first subject.

12. An electronic device, comprising:
a first housing portion that is pivotable relative to a second housing portion between:
a closed position concealing a first display while leaving an image capture device and a second display exposed; and
an axially displaced open position where each of the image capture device, the first display, and the second display are exposed; and
one or more processors operable with the image capture device;
wherein the one or more processors, upon the image capture device capturing an image depicting a first subject, augment the image with a model defined by reference locations situated at predefined features of a second subject at a position relative to depictions of the first subject to obtain an augmented image and cause the second display to present the augmented image while the image capture device is in a viewfinder mode of operation.

13. The electronic device of claim 12, wherein the one or more processors are further configured to present at least portions of viewfinder image content depicting a second subject with the augmented image while the image capture device is in the viewfinder mode of operation when the second subject is within a field of view of the image capture device.

14. The electronic device of claim 13, wherein the one or more processors cause the image capture device to capture another image once the at least portions of the viewfinder image content depict the second subject overlapping the model by a predefined overlapping amount.

15. The electronic device of claim 14, wherein the one or more processors further synthesize the image and the another image to obtain a composite image depicting the first subject and the second subject at the position relative to the depictions of the first subject.

16. The electronic device of claim 15, wherein the one or more processors augment the image by superimposing the model on the image.

17. The electronic device of claim 15, further comprising a depth imager, wherein a size of the model is a function of a distance the first subject is from the image capture device when the image is captured.

18. The electronic device of claim 15, wherein the image further depicts an inanimate object in addition to the first subject, wherein a size of the model is a function of a size of depictions of the first subject in comparison to a size of depictions of the inanimate object.

19. A method in an electronic device, the method comprising:
capturing, with an image capture device, an image depicting a first subject;
determining, by one or more processors using one or more sensors of the electronic device, a distance between the first subject and the image capture device;
generating, by the one or more processors, a skeletal model of a second subject positioned at a predefined orientation relative to depictions of the first subject as a function of the distance between the first subject and the image capture device;
superimposing, by the one or more processors, the skeletal model on the image to obtain an altered image;
causing, by the one or more processors, a display positioned adjacent to the image capture device to present the altered image; and
causing, by the one or more processors, viewfinder content to be presented with the altered image when a second subject is positioned within a field of view of the image capture device.

20. The method of claim 19, further comprising capturing another image depicting the second subject while at least substantially in the predefined orientation and synthesizing the another image with the image to depict the second subject and the first subject.
